(19) United States
(12) Patent Application Publication
(10) Pub. No.: US 2014/0226007 A1
(43) Pub. Date: Aug. 14, 2014

(54) Surveillance device with display module

(71) Applicant: G-STAR INTERNATIONAL TELECOMMUNICATION CO., LTD, (US)

(72) Inventor: Min-Chieh Hsu, Taipei City (TW)

(73) Assignee: G-STAR INTERNATIONAL TELECOMMUNICATION CO., LTD, Taipei City (TW)

(21) Appl. No.: 13/762,373

(22) Filed: Feb. 8, 2013

(51) Int. Cl. H04N 7/18

(52) U.S. Cl. CPC H04N 7/18
USPC 348/143

(57) ABSTRACT

A display module is set at one side of the surveillance device (CCTV), which can instantaneously monitor the images captured by the surveillance device (CCTV) without having to show the image via the computer screen connected to a remote digital video and audio storage device (DVR). The surveillance device with a display module has two capabilities of images recording and instant images monitoring.

### BACKGROUND OF THE INVENTION

1. Field of the Invention

This invention is related to a surveillance device (CCTV) with a display module, and more particular to a display module located on one side of a surveillance camera, which is used to instantly monitor the images captured by the surveillance camera.

2. Description of Related Art

Public security is always an important issue that everyone concerned. Therefore, how to reduce the crime rate has been the goal the police authorities are trying hard to achieve.

Besides larcenies, abrupt taking and robberies, the drunk driving hit and run are the most frequent criminal cases. However, these types of cases are difficult to find the escaped perpetrators, so that the police authorities can only investigate the images recorded on a monitoring screen to clarify the incident and return the justice to the families of the victims.

Therefore, the surveillance camera can be a useful tool to help the law enforcement officers to find the truth of a criminal case.

The surveillance cameras are commonly mounted in the streets, banks, convenience stores, shopping mall and department stores etc., which have the capability of deterring the offenders from crime. It is to be noted that the surveillance camera is important to the society.

However, conventional surveillance camera (CCTV) passes the captured images to a computer monitor via a remote digital audio and video storage device (DVR). So that the conventional surveillance camera (CCTV) is just an images recorder, which can not provide instant images recording and instant images monitoring at the same time.

Therefore, the conventional surveillance camera (CCTV) still has many defects, which are necessary to be improved.

### SUMMARY OF THE INVENTION

The objective of the present invention is to provide a surveillance device with a display module, which can instantaneously monitor the images captured by the surveillance device (CCTV) without having to show the images via the computer screen from a remote digital video/audio storage device (DVR). The surveillance device with a display module has two capabilities of images recording and instant images monitoring.

In order to solve the above mentioned deficiency and achieve the objective of the present invention, the present invention provides a surveillance device with a display module, including: at least one surveillance camera having a lens, a control circuit and a power supply module, wherein the lens and the power supply module are electrically connected to the control circuit respectively, and a display module disposed on at least one side of the surveillance camera and electrically connected to the control circuit.

Preferably, the surveillance camera further has an audio/video transmission line with two ends, one end thereof electrically connected to the control circuit of the surveillance camera, the other end thereof electrically connected to a host control circuit of a digital video and audio storage device (DVR).

Preferably, the display module is one selected from the following group consisting of: Liquid Crystal Display, Organic Light-Emitting Diode and Light Emitting Diode.

Preferably, the surveillance camera is one of a cylinder and a cuboid.

Preferably, the surveillance camera has a base on one side thereof.

Preferably, the base has a connecting structure on one side thereof.

Preferably, the connecting structure is located on left side of the base.

Preferably, the connecting structure is located on right side of the base.

Preferably, the connecting structure is one of a pivotal structure and a fixture structure.

Preferably, the pivotal structure is pivotally connected to a rotating structure, and the rotating structure has a shaft pivotally connected to the display module so as to allow the display module to adjust angles along x and y axes.

Preferably, the display module has a speaker and a microphone electrically connected to the control circuit.

Preferably, the surveillance camera has at least one light emitting element and the light emitting element is electrically connected to the control circuit.

Preferably, the surveillance camera has a connecting portion.

Preferably, the connecting portion is one of an engaging structure and a locking structure.

Preferably, the display module has an engaging portion so as to be engaged with the engaging structure.

Preferably, the locking structure has a locking element so as to be securely locked on the display module.

Preferably, the display module has a connecter on at least one side thereof.

Preferably, the connecter is one of an engaging member and a locking member.

Preferably, the display module is disposed on the top of the surveillance camera.

Preferably, the display module is disposed on the bottom of the surveillance camera.

Preferably, the display module is disposed on the left of the surveillance camera.

Preferably, the display module is disposed on the right of the surveillance camera.

Preferably, the control circuit has a radio transceiver circuit.

Preferably, at least one side of the surveillance camera has at least one light-emitting element.

Comparing to the prior art, the present invention has the following advantages and efficacy:

A display module set at one side of the surveillance camera of the present invention is different from the conventional surveillance camera, which can directly display the images captured by the surveillance camera via the control circuit to the display module.

Therefore the present invention is more prompt and instant than the conventional surveillance camera without passing the images captured by the surveillance camera to a computer monitor via a remote digital video and audio storage device (DVR). The present invention not only can show the instant images on the display module beside the surveillance camera, but also deter the offenders from crime, so as to effectively reduce the crime rate.

Therefore the present invention will be helpful to the national crime prevention.

### BRIEF DESCRIPTION OF THE DRAWINGS

The invention, as well as its many advantages, may be further understood by the following detailed description and drawings in which:

FIG. 1 is a schematic perspective view of a first embodiment of the present invention.

FIG. 2 is a perspective exploded view of a first embodiment of the present invention.

FIG. 3 is a schematic diagram showing the operation of the first embodiment of the present invention.

FIG. 4 is another schematic diagram showing the operation of the first embodiment of the present invention.

FIG. 5 is a schematic perspective view of a second embodiment of the present invention.

FIG. 6 is a schematic perspective view of a second embodiment with the light emitting element of the present invention.

FIG. 7 is a block flow diagram of the present invention.

FIG. 8 is a schematic perspective view of a third embodiment of the present invention.

FIG. 9 is a perspective exploded view of a third embodiment of the present invention.

FIG. 10 is a schematic perspective view of a fourth embodiment of the present invention.

FIG. 11 is a perspective exploded view of a fourth embodiment of the present invention.

FIG. 12 is a schematic perspective view of a fifth embodiment of the present invention.

FIG. 13 is a perspective exploded view of a fifth embodiment of the present invention.

FIG. 14 is a schematic perspective view of a sixth embodiment of the present invention.

FIG. 15 is a perspective exploded view of a seventh embodiment of the present invention.

FIG. 16 is a schematic perspective view of a eighth embodiment of the present invention.

FIG. 17 is a perspective exploded view of a ninth embodiment of the present invention.

### DETAILED DESCRIPTION OF THE INVENTION

The embodiments according to the drawings of the present invention are illustrated as the following:

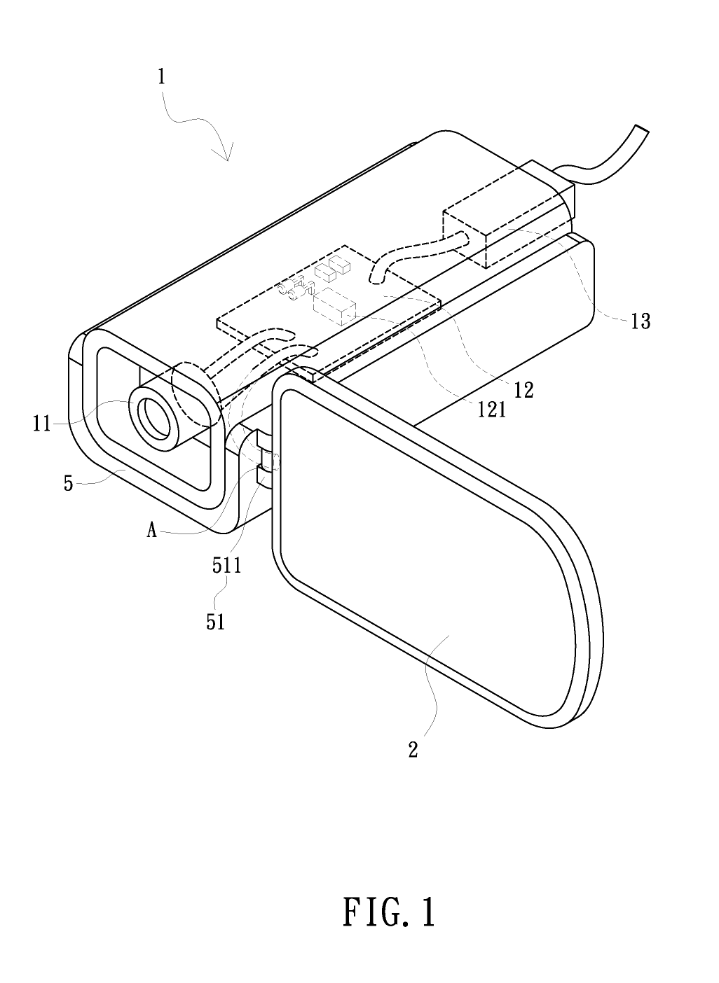

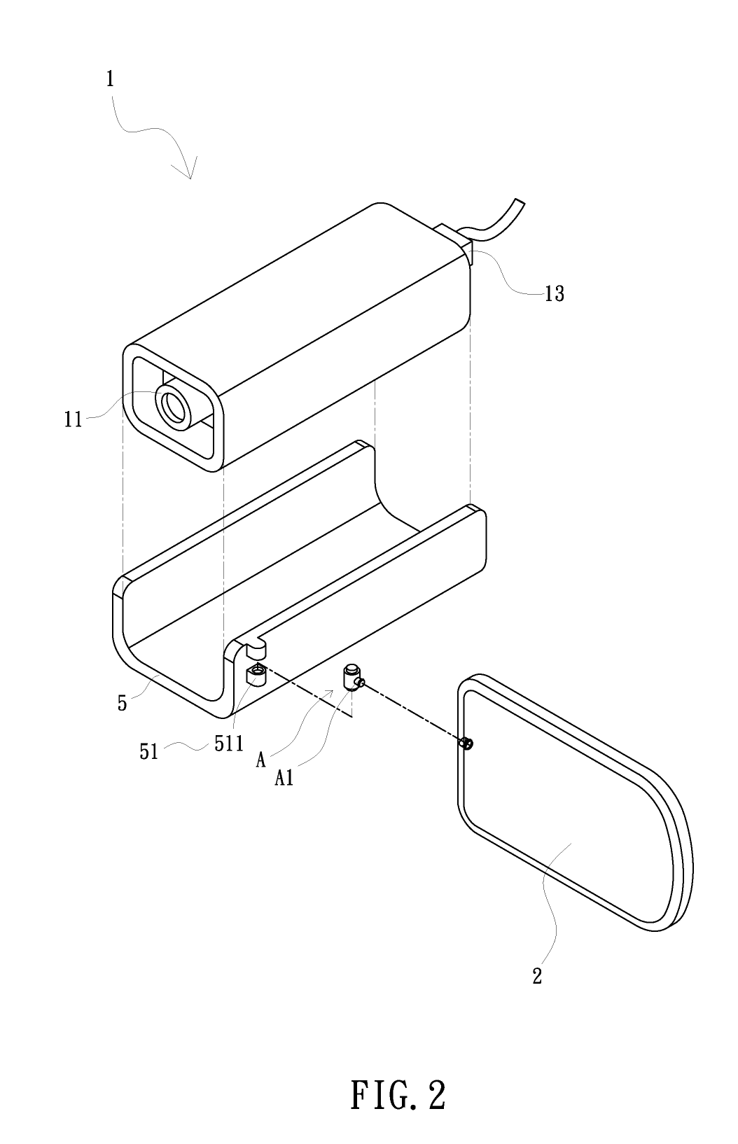

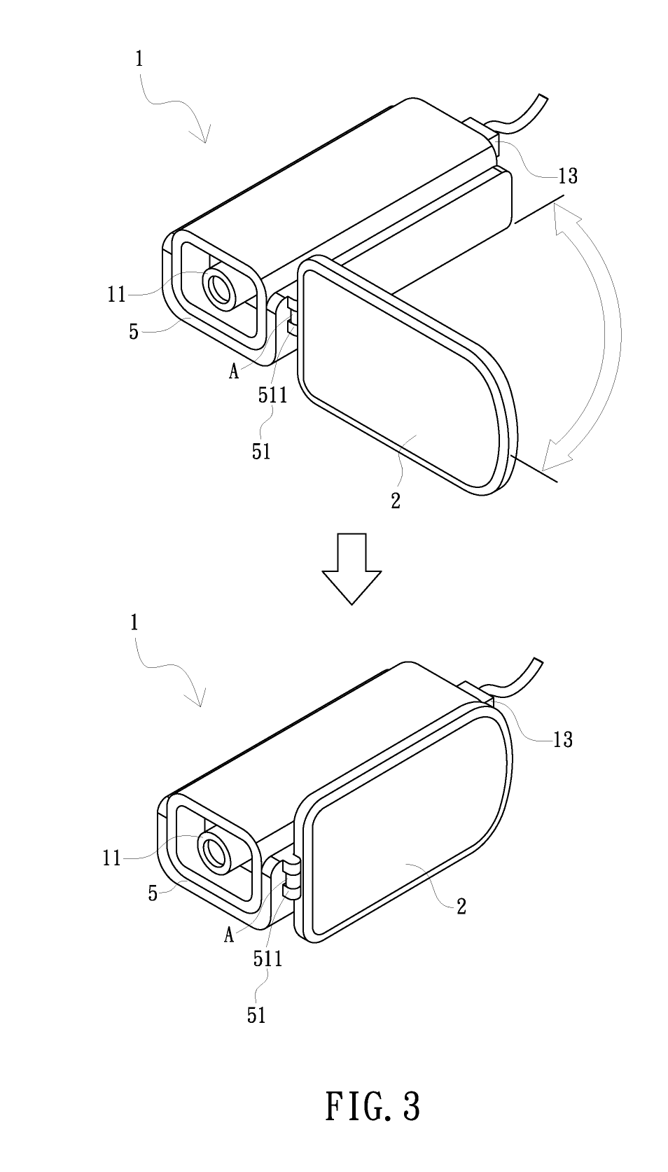

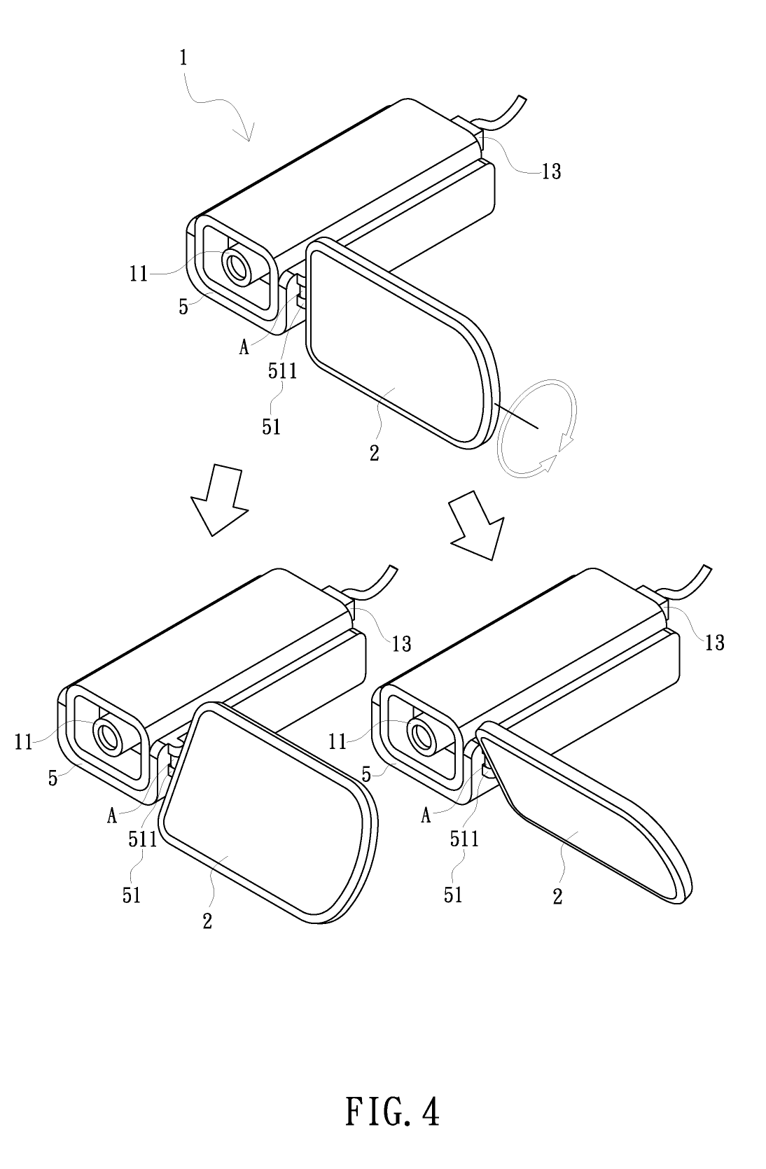

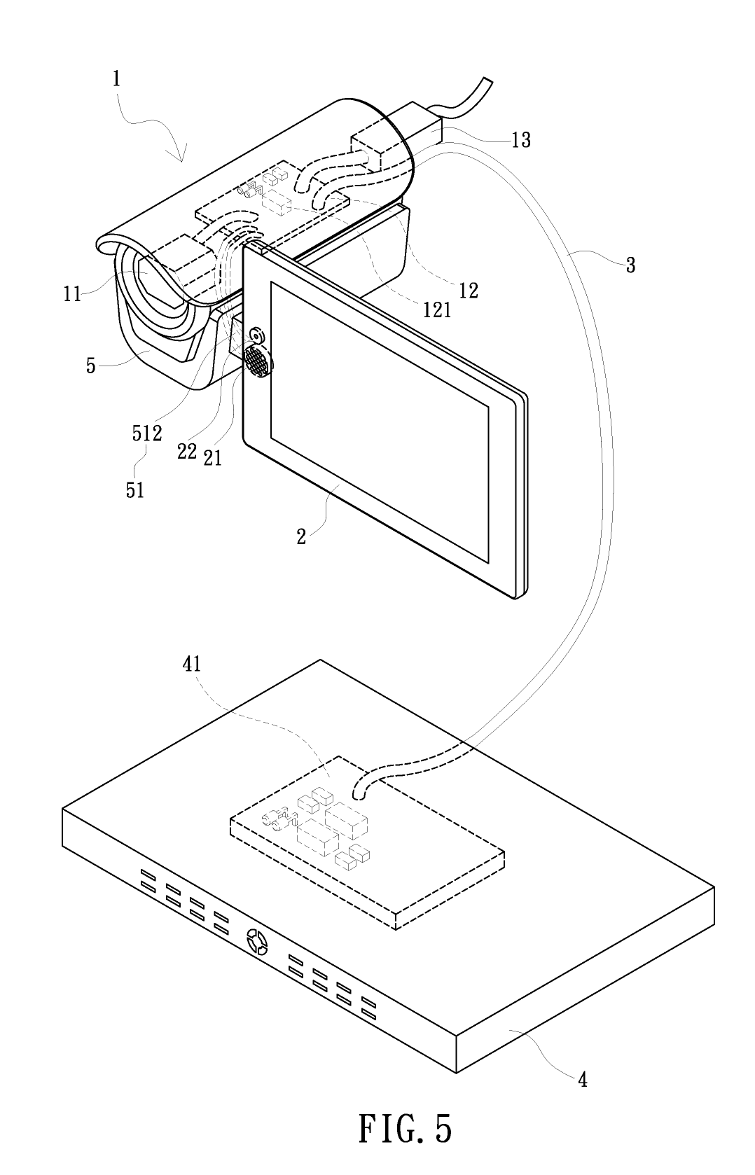

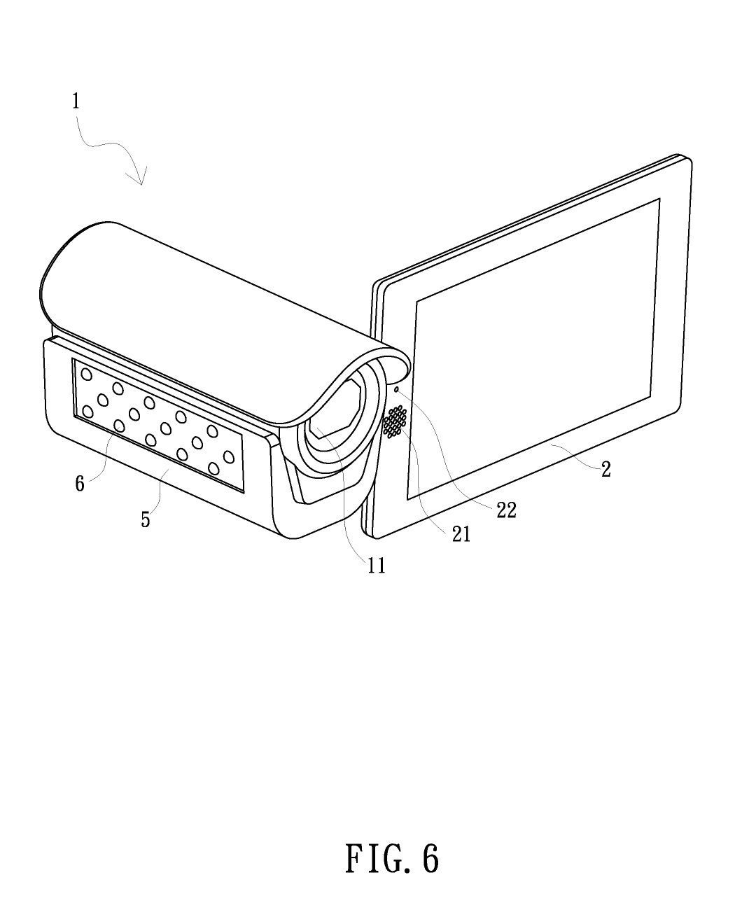

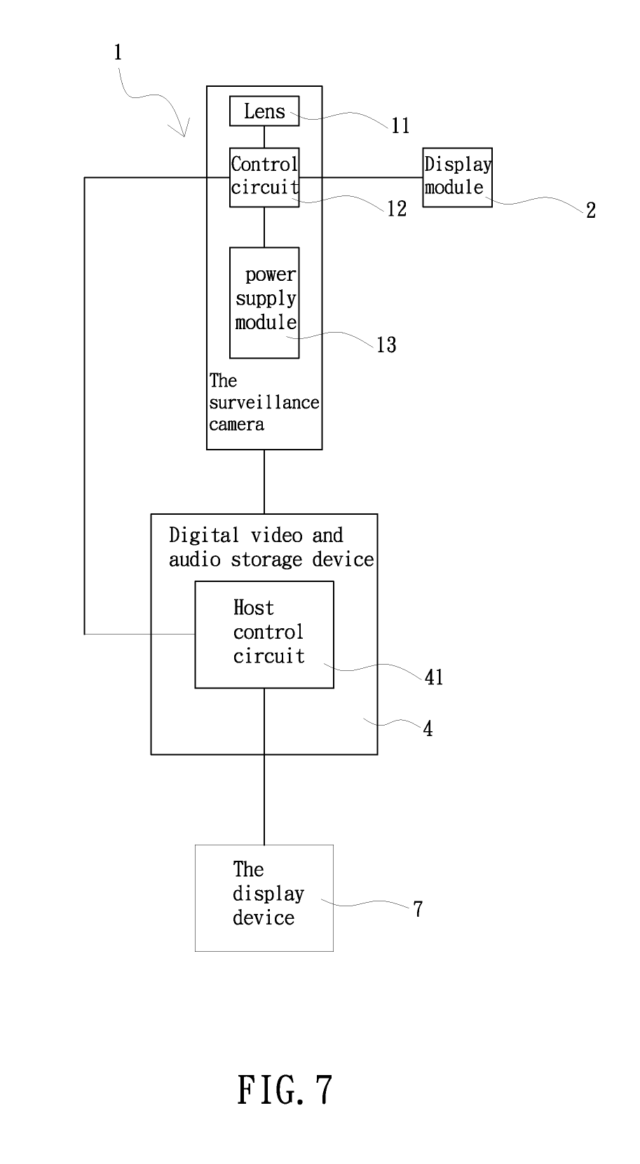

With reference to FIGS. 1 to 7, FIG. 1 is a schematic perspective view of a first embodiment of the present invention, FIG. 2 is a perspective exploded view of a first embodiment of the present invention, FIG. 3 is a schematic diagram showing the operation of the first embodiment of the present invention, FIG. 4 is another schematic diagram showing the operation of the first embodiment of the present invention, FIG. 5 is a schematic perspective view of a second embodiment of the present invention, FIG. 6 is a schematic perspective view of a second embodiment with the light emitting element of the present invention, FIG. 7 is a block flow diagram of the present invention.

As shown in the figures, the present invention provides a surveillance device with a display module, including: at least one surveillance camera 1 having a lens 11, a control circuit 12 and a power supply module 13, wherein the lens 11 and the power supply module 13 are electrically connected to the control circuit 12 respectively, and a display module 2 disposed on at least one side of the surveillance camera 1 and electrically connected to the control circuit 12.

Wherein, the display module 2 is set at one side of the surveillance camera 1, which can directly display the images captured by the lens 11 of the surveillance camera 1 via the control circuit 12 to the display module. The present invention not only greatly enhances the effectiveness of the surveillance camera, but also helps prevent crime. It would be a great benefit for the safety of people's life.

In this embodiment, the surveillance camera 1 further has an audio/video transmission line 3 with two ends, one end thereof electrically connected to the control circuit 12 of the surveillance camera 1, the other end thereof electrically connected to a host control circuit 41 of a digital video and audio storage device (DVR) 4.

Wherein, the host control circuit 41 is also connected to an external display device 7, such as: computers, mobile phones, personal digital assistants, so that the instant images captured by the lens 11 can be transmitted to the display device 7 via the audio and video transmission line 3 and the host control circuit 41 of the digital media storage device (DVR) 4, so that the real-time images can be shown on the on the monitor of the display device 7. Therefore, the instant images can be either monitored by local or remote display devices of the surveillance camera 1, so as to form monitor safety nets and to more effectively fight against crimes.

Wherein, the display module 2 is one selected from the following group consisting of: Liquid Crystal Display, Organic Light-Emitting Diode and Light Emitting Diode.

In this embodiment, the surveillance camera 1 is one of a cylinder and a cuboid, which offers multiple choices for the consumers.

Wherein, the surveillance camera has a base 5 on one side thereof and the base 5 has a connecting structure 51 on one side thereof, the connecting structure 51 is connected to the display module 2 via the base 5, the connecting structure 51 is located on left side of the base 5, and when the surveillance camera 1 is erected at a high position and in case of obstructions at the right side thereof, the connection structure 51 can be set at the left side of the base to avoid obstacles and to facilitate the combined mounting for the display module 2.

In this embodiment, the connecting structure 51 is located on right side of the base 5.

Wherein, when the surveillance camera 1 is erected at a high position and in case of obstructions at the left side thereof, the connection structure 51 can be set at the right side of the base to avoid obstacles and to facilitate the combined mounting for the display module 2.

In this embodiment, the connecting structure 51 could be one of a pivotal structure 511 and a fixture structure 512, which can be connected to the display module.

Wherein, the pivotal structure 511 is pivotally connected to a rotating structure A, and the rotating structure A has a shaft Al pivotally connected to the display module 2, which allows the display module 2 to adjust the angle along the x and y axes.

Wherein, the display module 2 can adjust the angle along the y-axis via the pivotal structure 511 and the rotating structure 52. Secondly, the display module 2 through the rotating shaft 521 of the rotating structure 52, and the display module 2 can adjust the angle along the x-axis via the shaft 521 of the rotating structure 52. Briefly, the display module 2 can adjust the angle along the x and y axes.

The display module 2 has a speaker 21 and a microphone 22 electrically connected to the control circuit 12.

Wherein, the microphone 22 can be used to receive outside sounds and the speaker 21 can broadcast the received outside sound.

The surveillance camera 1 has at least one light emitting element 6 electrically connected to the control circuit 12.

The light-emitting element 6 set on the surveillance camera 1 highlights the position of the surveillance camera 1 in the night, so as to achieve the effect of deterring the offenders. Secondly, it is easy to judge whether the surveillance camera 1 is in a normal operation via the light-emitting element 6, so that the failure maintenance can be effective and rapidly.

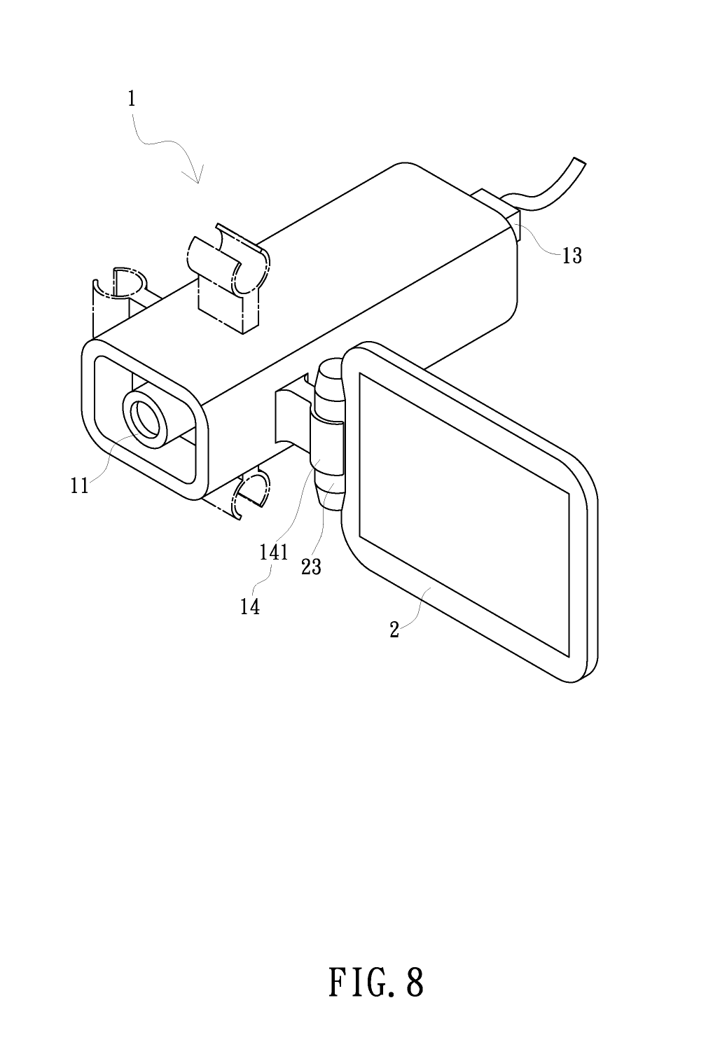

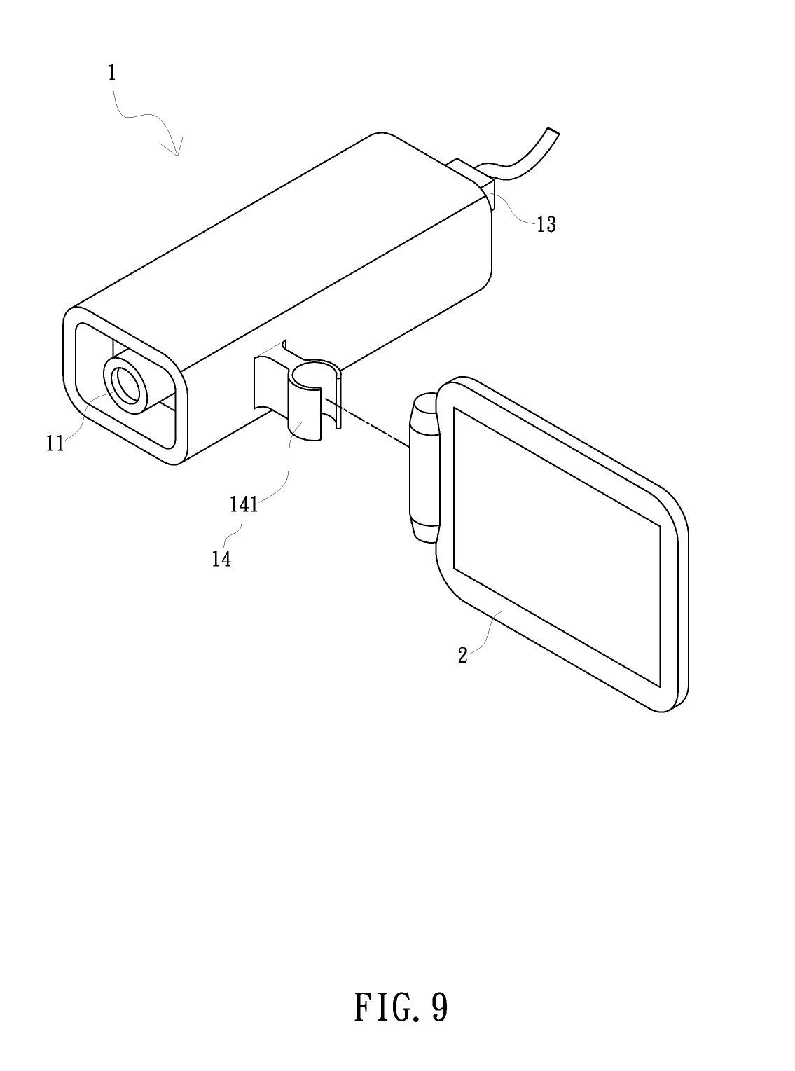

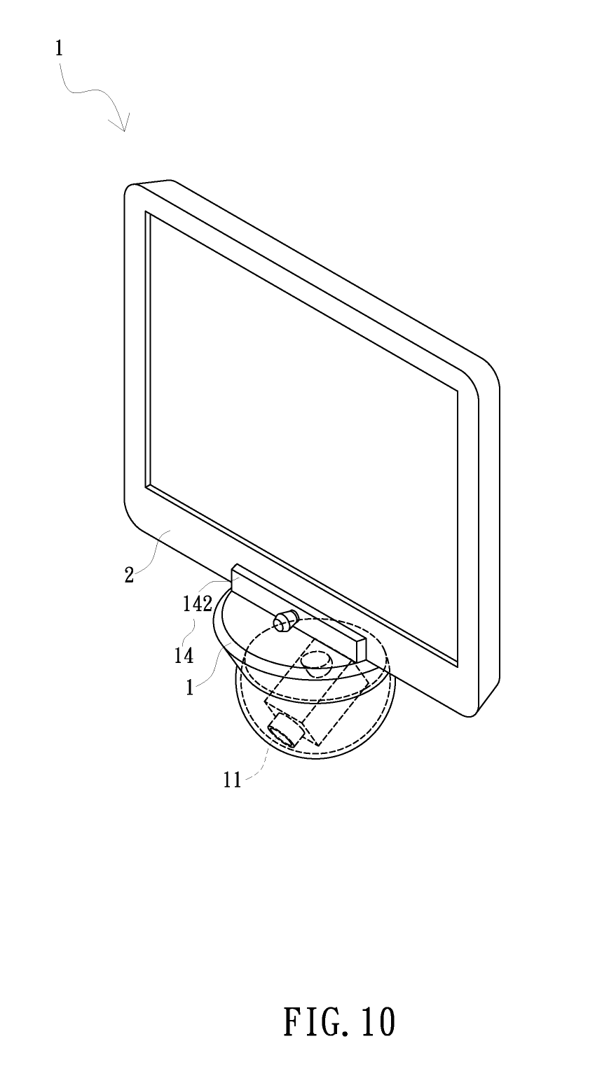

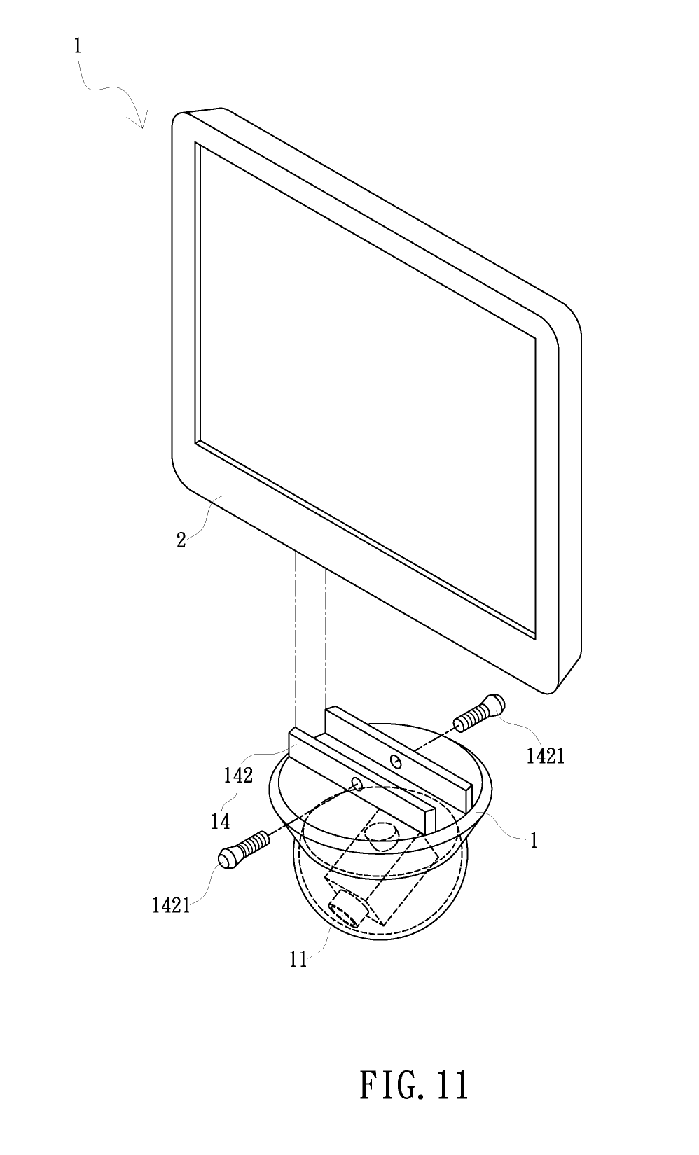

As shown in the figures, FIG. 8 is a schematic perspective view of a third embodiment of the present invention. FIG. 9 is a perspective exploded view of a third embodiment of the present invention. FIG. 10 is a schematic perspective view of a fourth embodiment of the present invention. FIG. 11 is a perspective exploded view of a fourth embodiment of the present invention.

In this embodiment, the surveillance camera 1 has a connecting portion 14 on at least one side thereof and the connecting portion 14 can be connected to the display module 2.

Wherein, the connecting portion 14 could be one of an engaging structure 141 and a locking structure 142, which can be connected to the display module 2.

The display module 2 has an engaging portion 23 on at least one side thereof so as to be engaged with the engaging structure 141.

Wherein, the locking structure 142 has a locking element 1421 so as to be securely locked on the display module 2.

Wherein, the locking element 1421 can be a screw so as to securely lock the surveillance camera 1 on the display module 2.

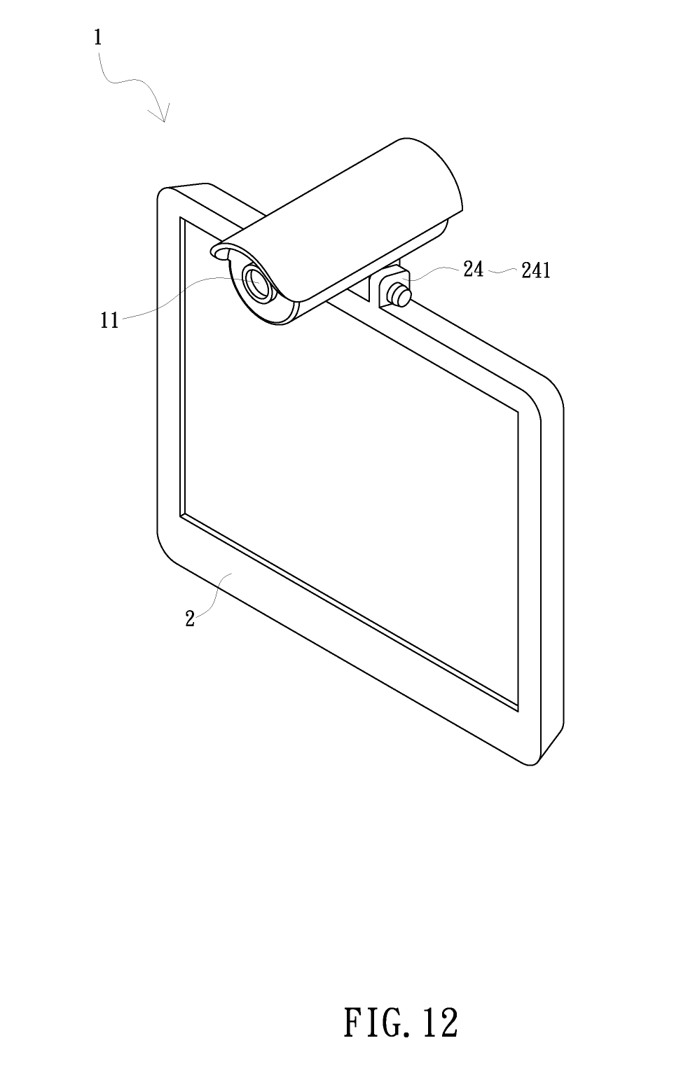

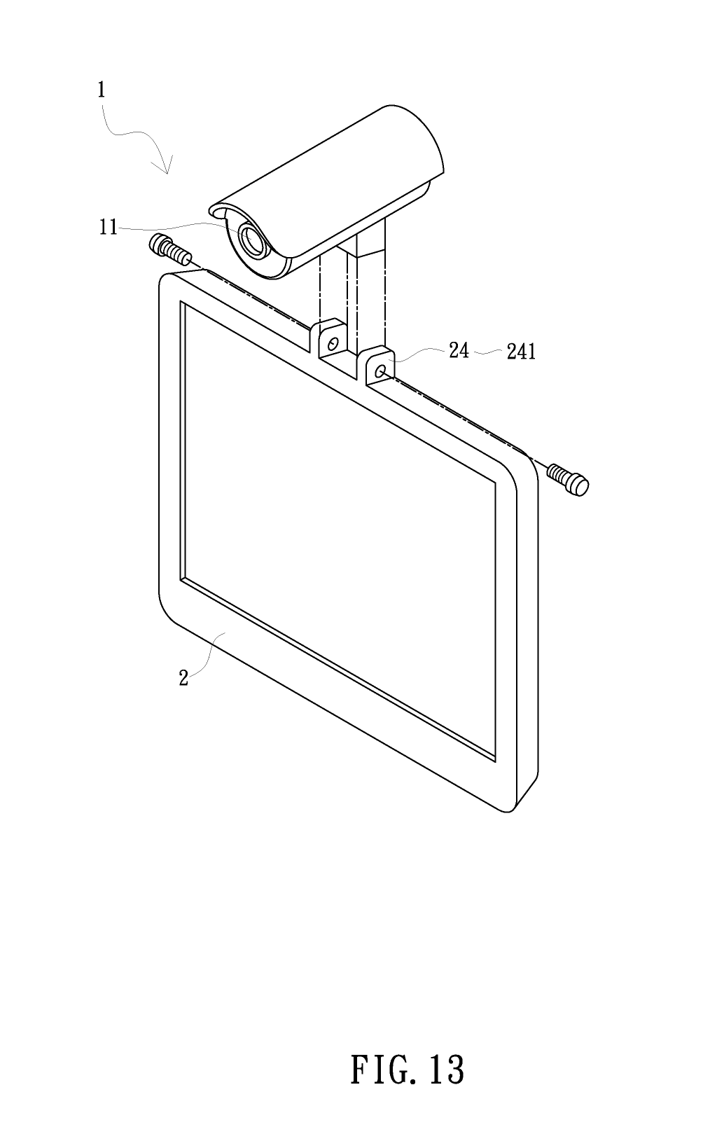

As shown in the figures, FIG. 12 is a schematic perspective view of a fifth embodiment of the present invention. FIG. 13 is a perspective exploded view of a fifth embodiment of the present invention.

In this embodiment, the display module 2 has a connecter 24 on at least one side thereof so as to be connected to the surveillance camera 1.

Wherein, the connecter 24 set on the display module 2 could be one of an engaging member and a locking member 241, which can be connected to the surveillance camera 1.

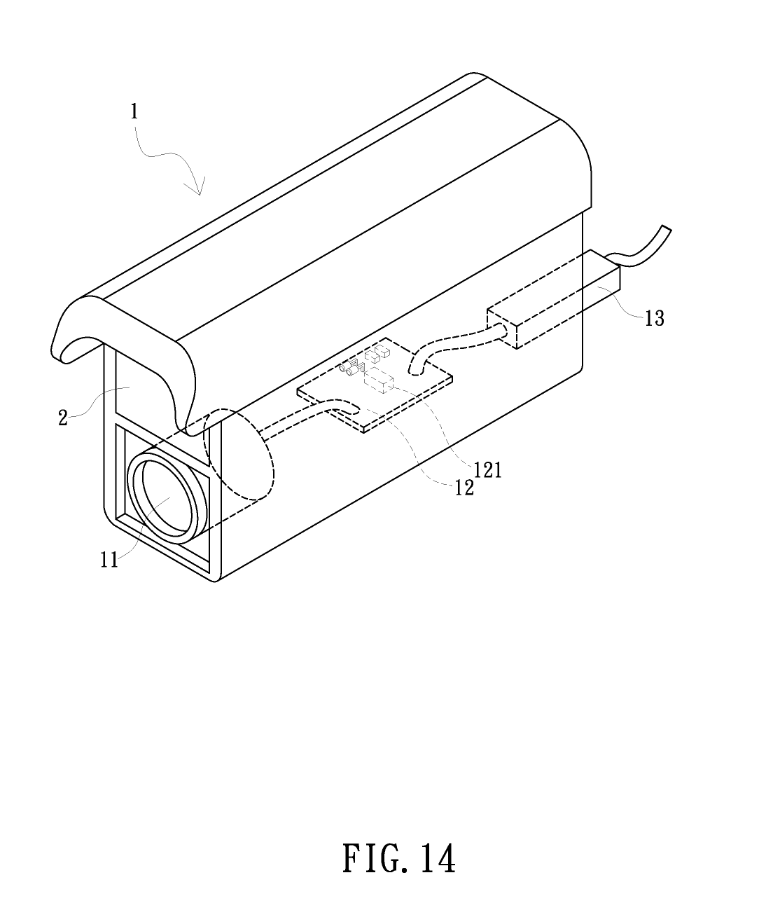

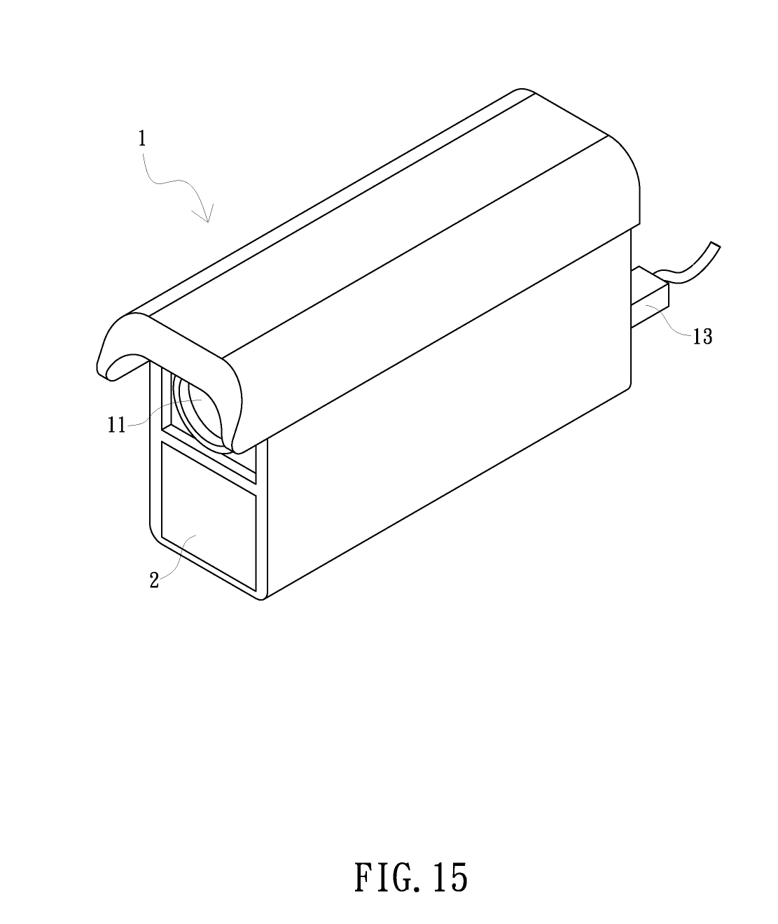

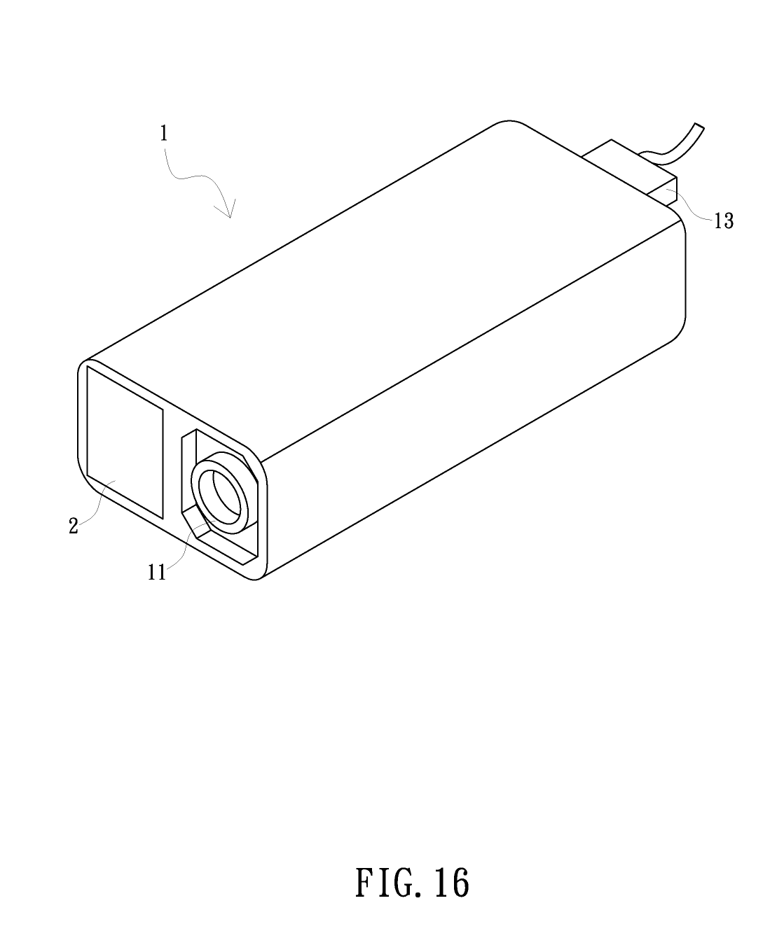

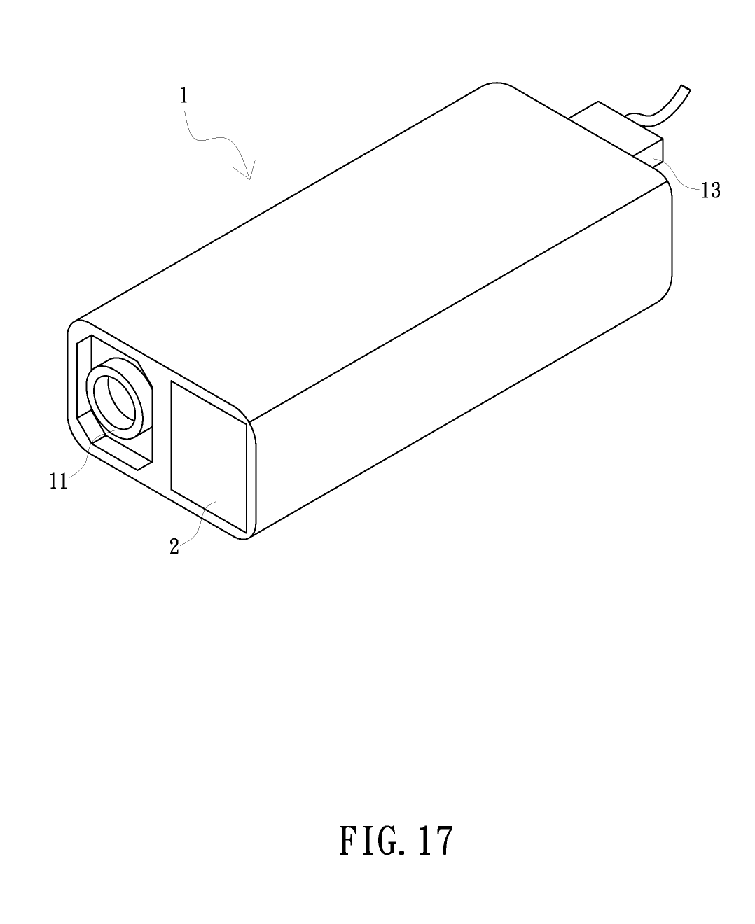

As shown in the figures, FIG. 14 is a schematic perspective view of a sixth embodiment of the present invention. FIG. 15 is a perspective exploded view of a seventh embodiment of the present invention. FIG. 16 is a schematic perspective view of a eighth embodiment of the present invention. FIG. 17 is a perspective exploded view of a ninth embodiment of the present invention.

In this embodiment, the display module 2 is disposed on the top of the surveillance camera 1 so as to provide different shape of the present invention.

In another embodiment, the display module 2 is disposed on the bottom of the surveillance camera 1 so as to provide different shape of the present invention.

In another embodiment, the display module 2 is disposed on the left of the surveillance camera 1 so as to provide different shape of the present invention.

In another embodiment, the display module 2 is disposed on the right of the surveillance camera 1 so as to provide different shape of the present invention.

Wherein, the control circuit 12 has a radio transceiver circuit 121.

Wherein, the radio transceiver circuit 121 can receive a digital TV signal, and displayed on the display module 2.

In summary, the embodiments of the present invention can really achieve the expected effect, and the concrete structure of the present invention has neither been seen in similar products, nor been disclosed in prior art. Indeed, this present invention is patentable and completely meets the requirement of the Patent Law.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A surveillance device with a display module, comprising:
at least one surveillance camera having a lens, a control circuit and a power supply module, wherein the lens and the power supply module are electrically connected to the control circuit respectively; and
a display module disposed on at least one side of the surveillance camera and electrically connected to the control circuit.

2. The device as claimed in claim 1, wherein the surveillance camera further has an audio/video transmission line with two ends, one end thereof electrically connected to the control circuit of the surveillance camera, the other end thereof electrically connected to a host control circuit of a digital video and audio storage device (DVR).

3. The device as claimed in claim 1, wherein the display module is one selected from the following group consisting of: Liquid Crystal Display, Organic Light-Emitting Diode and Light Emitting Diode.

4. The device as claimed in claim 1, wherein the surveillance camera is one of a cylinder and a cuboid.

5. The device as claimed in claim 1, wherein the surveillance camera has a base on one side thereof.

6. The device as claimed in claim 5, wherein the base has a connecting structure on one side thereof.

7. The device as claimed in claim 6, wherein the connecting structure is located on left side of the base.

8. The device as claimed in claim 6, wherein the connecting structure is located on right side of the base.

9. The device as claimed in claim 6, wherein the connecting structure is one of a pivotal structure and a fixture structure.

10. The device as claimed in claim 9, wherein the pivotal structure is pivotally connected to a rotating structure, and the rotating structure has a shaft pivotally connected to the display module so as to allow the display module to adjust angles along x and y axes.

11. The device as claimed in claim 6, wherein the display module has a speaker and a microphone electrically connected to the control circuit.

12. The device as claimed in claim 6, wherein the surveillance camera has at least one light emitting element and the light emitting element is electrically connected to the control circuit.

13. The device as claimed in claim 1, wherein the surveillance camera has a connecting portion.

14. The device as claimed in claim 11, wherein the connecting portion is one of an engaging structure and a locking structure.

15. The device as claimed in claim 1, wherein the display module has an engaging portion so as to be engaged with the engaging structure.

16. The device as claimed in claim 14, wherein the locking structure has a locking element so as to be securely locked on the display module.

17. The device as claimed in claim 1, wherein the display module has a connecter on at least one side thereof.

18. The device as claimed in claim 17, wherein the connecter is one of an engaging member and a locking member.

19. The device as claimed in claim 6, wherein the display module is disposed on the top of the surveillance camera.

20. The device as claimed in claim 6, wherein the display module is disposed on the bottom of the surveillance camera.

21. The device as claimed in claim 6, wherein the display module is disposed on the left of the surveillance camera.

22. The device as claimed in claim 6, wherein the display module is disposed on the right of the surveillance camera.

23. The device as claimed in claim 1, wherein the control circuit has a radio transceiver circuit.
